(19) United States
(12) Patent Application Publication
(10) Pub. No.: US 2022/0198283 A1
(43) Pub. Date: Jun. 23, 2022

(54) DYNAMIC RECONSTRUCTION OF DECISION TREE STRUCTURES

(71) Applicant: PayPal, Inc., San Jose, CA (US)

(72) Inventor: Prabin Patodia, Bangalore (IN)

(21) Appl. No.: 17/131,188

(22) Filed: Dec. 22, 2020

(51) Int. Cl. G06N 5/00; G06F 16/22; G06F 21/62; G06K 9/62

(52) U.S. Cl. CPC G06N 5/003; G06K 9/6282; G06F 21/6227; G06F 16/2246

(57) ABSTRACT

Techniques are disclosed relating to dynamic construction of decision tree structures. In various embodiments, a server system may receive, from a client device, a request to perform a particular operation via an application hosted by the server system. In some such embodiments, the request (e.g., an API request) may specify data values for one or more parameters. Based on a first parameter specified in the request, the server system may dynamically generate a first decision tree structure for an authorization policy used to determine whether to authorize the particular operation. In some embodiments, the first decision tree structure may include a first plurality of interconnected nodes organized into a first hierarchy having multiple levels, where a highest of the levels includes a first subset of nodes that correspond to the first parameter. Based on this first decision tree structure, the server system may then determine whether to authorize the request.

### BACKGROUND

### Technical Field

This disclosure relates generally to the use of decision tree structures by a computer system, and more particularly to dynamically reconstructing decision tree structures based on data provided in a request to perform an operation.

### Description of the Related Art

Server computer systems, such as web servers, application servers, email servers, etc., may provide various computing resources and services to end users. For example, a server system may provide remote users with access to software applications via a network and perform various computing operations on behalf of the requesting users. A server system will commonly implement a policy to control whether, or how, the application performs requested operations.

In some instances, these policies may include a set of rules that are to be applied when evaluating whether (or how) to perform a requested operation. A policy may be implemented using a decision tree structure in which a given rule of the policy may have one or more corresponding paths through the tree. To use a decision tree structure to evaluate a request, it is typically necessary to first retrieve data (e.g., data corresponding to the requesting user) from storage. In some instances, however, the process of retrieving the data, of which there may be a significant amount, may be time-consuming and computationally expensive, increasing the amount time it takes to perform the requested operation and degrading the performance of the server system as a whole.

### BRIEF DESCRIPTION OF THE DRAWINGS

FIG. 1 is a block diagram illustrating an example server system that is operable to dynamically construct decision tree structures, according to some embodiments.

FIGS. 2A-2B are block diagrams illustrating example decision tree structures, according to some embodiments.

FIG. 3A is a diagram depicting an example request for a server system to perform a particular operation, according to some embodiments. FIG. 3B is a diagram illustrating an example key-value representation of a policy associated with the particular requested operation. FIG. 3C is a block diagram illustrating an example decision tree structure, according to some embodiments.

FIG. 4 is a block diagram illustrating an example server system that is operable to generate a key-value representation of a policy, according to some embodiments.

FIG. 5 is a flow diagram illustrating an example method for dynamically generating a decision tree structure, according to some embodiments.

FIG. 6 is a flow diagram illustrating an example method for retrieving a decision tree structure dynamically based on information included in a request, according to some embodiments.

FIG. 7 is a flow diagram illustrating an example method for dynamically reconstructing a decision tree structure, according to some embodiments.

FIG. 8 is a block diagram illustrating an example computer system, according to some embodiments.

### DETAILED DESCRIPTION

A server system may provide various web services to users in which the computing resources of the server system (including hardware or software elements of the server system) perform computing operations on behalf of a requesting user. Non-limiting examples of web services a server system may provide include email services, social media services, streaming media services, online payment services, etc. In many instances, a software application hosted by a server system may implement various rules that control whether, and how, the application performs various requested operations as part of the web service. As a non-limiting example, when a server system receives a request from a client to perform a particular operation, it may utilize one or more rules to determine whether to authorize the requested operation depending, for example, on information about the requesting user (e.g., the user's country of residence, recent activity using the web service, etc.).

In many instances, such rules are initially developed by policy teams (e.g., compliance officers) who specify a written policy, for example as a series of sentences or paragraphs explaining the operation of the rules. Consider, as one non-limiting example, the following written policy that may be used to determine whether to authorize a transfer of funds between users (in embodiments in which a server system provides an online payment service):

1. For US citizen sending money using CC, apply Logic Test 1

2. For US citizen sending money using ACH, apply Logic Test 2

3. For US citizen receiving money using CC, apply Logic Test 3

4. For US citizen receiving money using ACH, apply Logic Test 4

5. For EU citizen sending money using PAD, apply Logic Test 5

6. For EU citizen sending money using ECHECK, apply Logic Test 6

7. For EU citizen receiving money using PAD, apply Logic Test 7

8. For EU citizen receiving money using ECHECK, apply Logic Test 8

These rules may then be provided to a user (e.g., one or more software developers or rule writers), who translates the rules into a format that may be implemented by the server system (e.g., source code specifying a series of nested conditional statements operable to implement the rules of the policy, when executed).

When converted from a plain language format (e.g., a series of sentences or paragraphs) into a format that can be used by the server system, the structure of such rules typically form a decision tree in which a given rule has one or more corresponding flow paths through the decision tree. It is often the case that there can be multiple different, though logically equivalent, ways to structure a decision tree that implements a particular policy, the particular structure chosen being a design choice of the person translating the policy to rules/logic. Given the same policy, two rule-writers may create entirely different decision trees that both implement the logic of the policy. For example, presented with the policy above, a resulting decision tree could take any of the following flow hierarchies, as desired by the rule-writers:

Sender/Receiver->Country->Financial Instrument->Logic Test

Country->Sender/Receiver->Financial Instrument->Logic Test

Financial Instrument->Country->Sender/Receiver->Logic Test

To evaluate a request using a decision tree, the server system first needs to load (at least a portion of) the data that is referenced by the tree. For example, to evaluate a given node in the decision tree, the server system may need multiple items of data corresponding to the user, such as the user's IP address, email address, SSN, physical address, information regarding the user's recent activity via the service, etc. Additionally, the different nodes in the decision tree may have different data requirements such that, to use the decision tree, a significant amount of data may need to be loaded (e.g., from persistent storage). When the server system (and, more specifically, the application) receives a request to perform an operation (e.g., from an end user of a client device), it may retrieve the relevant decision tree, load data referenced by the decision tree (e.g., data corresponding to the end user), and then execute the decision tree using the relevant subset of the loaded data to determine whether to authorize the requested operation.

Using one prior technique, the server system may pre-fetch all of the data that could possibly be needed by the decision tree during the actual execution of the decision. This approach presents various technical shortcomings, however. For example, it is not uncommon for a decision tree to have many (e.g., 1,000, 5,000, 10,000, etc.) flow paths, each of which may have many conditions requiring a variety of data to be loaded before that flow path can be evaluated. As such, loading all of the data that could potentially be used by a decision tree at runtime is both slow and computationally expensive.

To avoid loading all of the data referenced in a decision tree, a server system may attempt to determine, at runtime, the path(s) through the decision tree that could possibly be taken for a given request based, for example, on the information included in the request. For example, in some embodiments, the request to perform an operation may be an application programming interface (“API”) request that includes data values for one or more parameters (e.g., data relating to the requesting user, the details of the requested operation, etc.). Based on the data included in such a request, the server system may attempt to identify those rule flow paths through the decision tree that could potentially be evaluated and load the data utilized by those paths.

This technique also presents various technical shortcomings, however. For example, when a client device sends a request to the server system, the request typically only includes those items of data that are required or supported by the API being invoked. Using the prior “static decision tree” techniques, the less information contained in the request, the greater the number of nodes for which the server system will need to pre-load data. Accordingly, because the data included in a request rarely includes sufficient information to definitively determine which path will ultimately be taken through a decision tree, the server system will likely still need to load data for a (potentially large) number of flow paths (e.g., hundreds to tens of thousands of flow paths) through the decision tree. Since a decision will only take one flow path through the decision tree, however, this technique still results in a large amount of data being pre-fetched that is not ultimately needed during the evaluation of the decision tree. Further, Applicant notes that the way in which a given decision tree is structured may significantly affect the ability of the server system to accurately predict the path that will be taken through the decision tree, which, depending on the items of information specified in a request, may negatively impact the server system's ability to implement the policy in a fast, computationally efficient manner.

In various embodiments, however, the disclosed techniques may solve these and other technical problems by using dynamic decision tree structures to implement rules-based policies. Stated differently, in various embodiments, the disclosed techniques include dynamically reconstruct (e.g., at runtime) decision tree structures, based on the data included in an API request, in a manner that reduces the number of potential rule flow paths that could be taken through the decision tree for a given request. This, in turn, may reduce the amount of data that the server system needs to load to evaluate the decision tree for the request.

For example, in some embodiment, the server system may receive, from a client device, a request to perform a particular operation via a service provided by the server system. This request (e.g., an API request) may specify data values for various parameters. In some such embodiments, the server system may determine whether to authorize the request based on a decision tree that specifies a rules-based policy associated with the particular operation. For example, in some embodiments, the server system may retrieve a key-value representation of the decision tree, where the key-value representation of the decision tree specifies various conditions (also referred to herein as “keys”) and the possible values that each of those conditions may take. Referring again to the non-limiting example policy provided above, the key-value representation of a decision tree for this policy may specify that the citizenship of the user is a condition and that this condition may take the values of either “US citizen” or “EU member-state citizen.”

Further, in various embodiments, the server system may identify one or more of the parameters for which the request includes a corresponding data value and, based on this information, generate a first decision tree structure using the key-value representation. In various embodiments, the server system generates this first decision tree structure so as to reduce the number of potential rule flow paths through the decision tree that may be taken based on the information included in the request. For example, if the request includes a data value for a first parameter, the server system may generate the first decision tree structure such that the highest level (or one of the highest levels) of the tree corresponds to a condition for that parameter, as described in greater detail below. Using this first decision tree structure, the server system may identify one or more data items corresponding to a user of the client device that need to be retrieved to evaluate the potential flows through the decision tree, and, after loading this data, use the first decision tree structure to reach an authorization determination.

Note that, in various embodiments, the amount of data (e.g., corresponding to the user) that is pre-fetched using the disclosed techniques is significantly reduced relative to the prior techniques described above. That is, by dynamically generating the decision tree structure based on the data available in the request and then finding the possible set of paths, the disclosed techniques may greatly reduce the number of possible paths for a given request and, accordingly, the number of data loads performed by the service. Thus, in various embodiments, the disclosed techniques may improve the speed and computational efficiency with which a server system can implement various rules-based policies and provide its web services, improving the functioning of the server system as a whole.

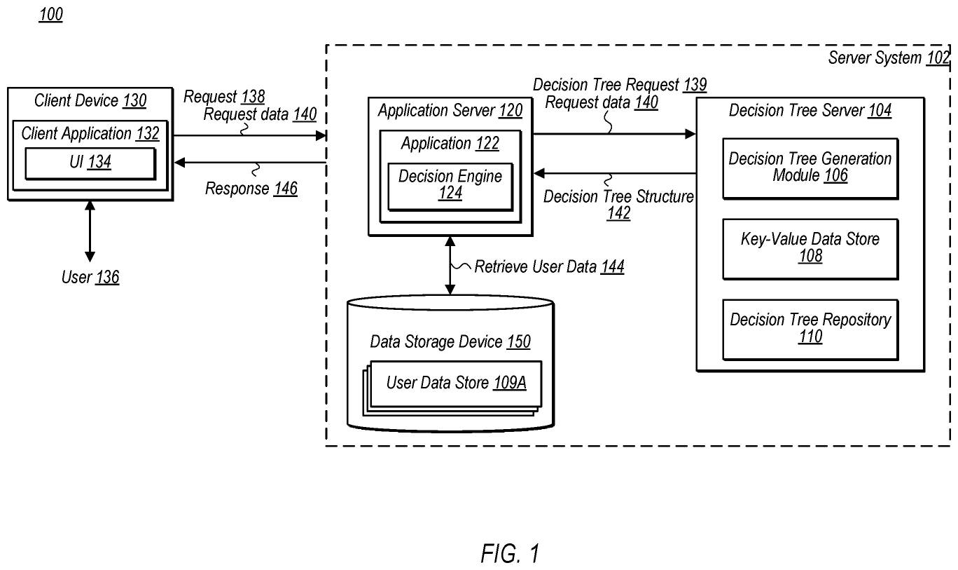

In FIG. 1, block diagram 100 depicts a server system 102 that, in various embodiments, is operable to dynamically construct decision tree structures (e.g., at runtime). For example, in various embodiments, server system 102 is operable to provide one or more computing resources (e.g., as part of one or more web services) to various end users over one or more networks (not shown, for clarity). In the depicted embodiment, server system 102 includes application server 120 hosting application 122, which may be accessed by user 136 over one or more networks using client device 130. As one non-limiting example, server system 102, in some embodiments, provides an online payment service that may be used by end users to perform online financial transactions (e.g., sending or receiving funds) or utilized by merchants to receive funds from users during financial transactions, as described above. Note, however, that this embodiment is described merely as one non-limiting example. In other embodiments, server system 102 may be used to provide any of various suitable web services (e.g., an email service, streaming media service, etc.) and application server 120 may be used to host any of various types of applications 122. Further, note that although only a single application server 120 is depicted in FIG. 1, this simplified embodiment is provided merely as a non-limiting example. In other embodiments, server system 102 may include any suitable number of application servers 120, any of which may host one or more applications 122. Additionally, note that, in various embodiments, server system 102 may include various additional elements not explicitly shown in FIG. 1 for clarity, such as web servers, database servers, networking devices, etc.

FIG. 1 further includes client device 130 that is used by user 136. Client device 130 may be any of various suitable computing devices, such as a smartphone, laptop computer, desktop computer, tablet computer, etc. that user 136 may use to access application 122 hosted by application server 120. For example, in various embodiments, client device 130 executes a client application 132, such as a web browser or dedicated software application, with a user interface (UI) 134 that the user 136 may use to access one or more computing resources provided by application server 120, such as client application 132.

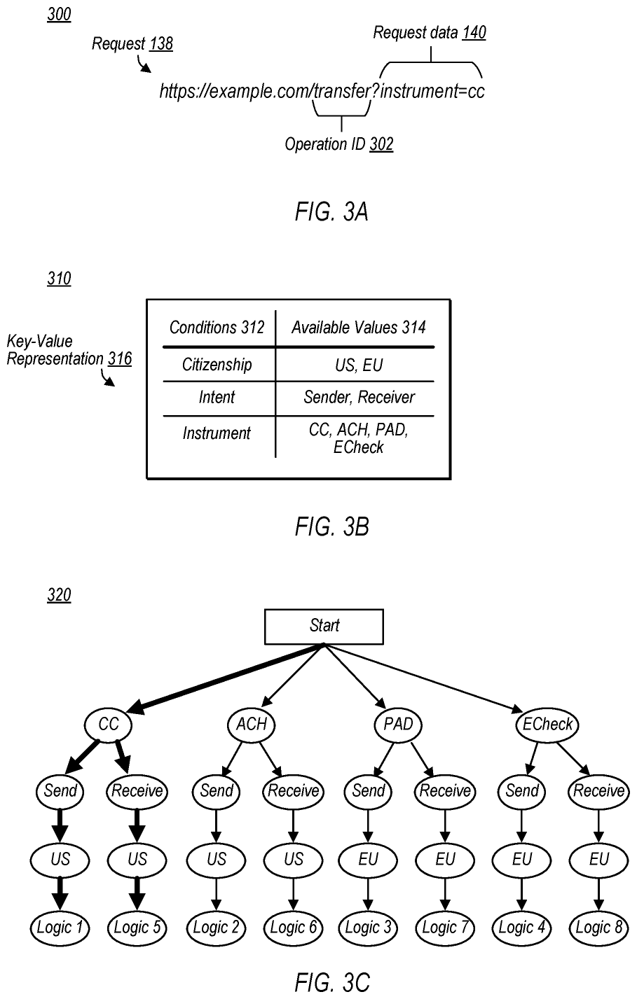

Application 122 may perform various operations as part of providing computing resources to user 136 of client device 130. As noted above, whether and how the application 122 performs a requested operation may be governed by a policy that includes one or more rules that specify, for example, the conditions under which a requested operation may be performed, variations on the manner in which the operation is to be performed under different circumstances, etc. Further, as noted above, when converted into a format usable by the server system 102 to implement such a policy, these rules may take the form of a decision tree in which a given rule may be represented by one or more “paths” through the tree. In various embodiments of the present disclosure, application 122 may utilize one or more decision tree structures 142 corresponding to a policy (e.g., an authorization policy) to determine whether, or how, it performs a given operation requested by an end user. For example, in the depicted embodiment, user 136 may send a request 138 to server system 102 requesting that application 122 perform a computing operation as part of a service it provides. Such a request 138 is described in more detail below with reference to FIG. 3A, according to one non-limiting embodiment. For the purposes of the present discussion, however, note that, in various embodiments, request 138 may include one or more items of request data 140. For example, in some embodiments, request 138 may be an API request sent to an API endpoint URI exposed by the server system 102 and the request 138 may include, as the request data 140, one or more data values for one or more parameters. In various embodiments, once application 122 receives the request 138, the disclosed techniques may use the request data 140 to dynamically construct a decision tree structure 142 for a policy associated with the requested operation.

Server system 102 further includes decision tree server 104, which, in the depicted embodiment, includes decision tree generation module 106, key-value data store 108, and decision tree repository 110. In various embodiments, once it receives the request 138, application 122 may send a decision tree request 139 to the decision tree server 104. As shown in FIG. 1, this request may include some or all of the request data 140 included in the request 138 from the client device 130. For example, in instances in which the request 138 is an API call that includes a data value for one or more parameters, the request to the decision tree server 104 may include information identifying the parameters for which a data value was provided in the request 138.

In various embodiments, decision tree generation module 106 is operable to dynamically generate (also referred to herein as “reconstructing”) a decision tree structure 142 based on the request data 140 specified in the request 138. Stated differently, in various embodiments, the decision tree generation module 106 is operable to construct a customized decision tree structure 142 that is organized in a manner that reduces the amount of data that will need to be retrieved (e.g., from persistent storage, such as data storage device 150) when evaluating the decision tree structure 142 to determine whether or how to perform the requested operation.

For example, in various embodiments, the decision tree request 139 may include, in addition to the request data 140, an identifier of the requested operation or of a policy used to evaluate requests to perform the requested operation. Further, in the depicted embodiment, the decision tree server 104 includes a key-value data store 108 that may store key-value representations of multiple policies that are associated with various possible computing operations provided by application 122 (or other applications hosted by application servers within the server system 102). In some such embodiments, based on the identifier of the requested operation, the decision tree generation module 106 may retrieve, from key-value data store 108, a key-value representation of a policy (e.g., an authorization policy) associated with the requested operation, which may be used to generate decision tree structures 142. The key-value representation of the policy, according to some embodiments, is described in greater detail below with reference to FIG. 3B.

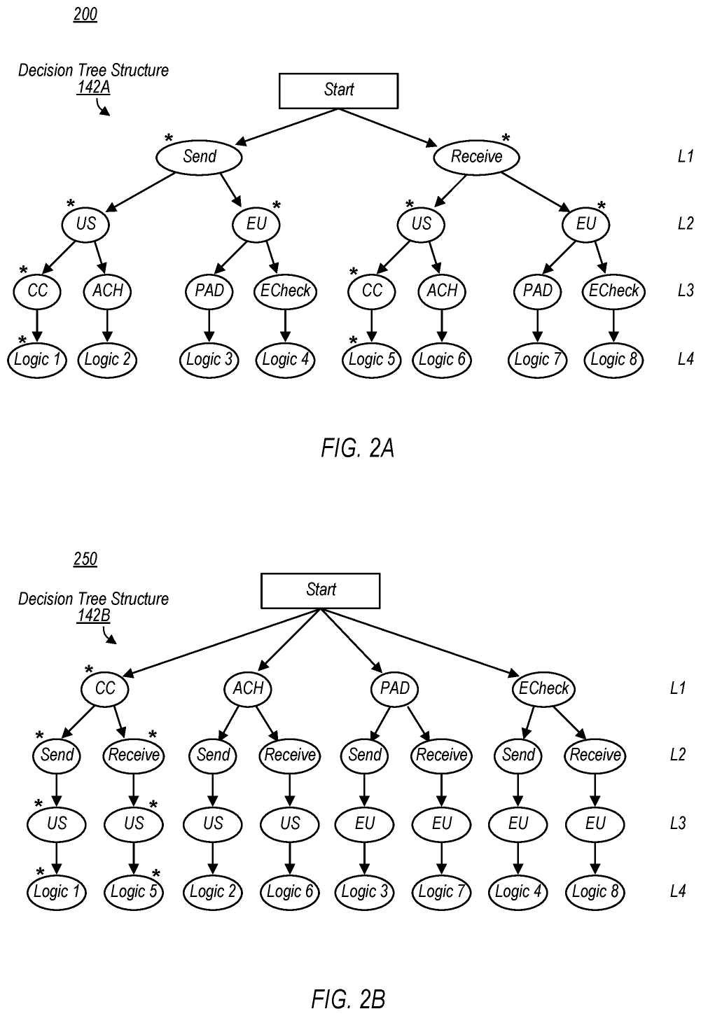

Using this key-value representation for the policy, the decision tree generation module 106 may generate a decision tree structure 142 based on the request data 140 included in the request 138. The manner in which the decision tree generation module 106 constructs the decision tree structure, according to some embodiments, is described in greater detail below with reference to FIGS. 2A-2B and 3A-3C. For the purposes of the present discussion, note that, in various embodiments, the decision tree structure 142 may include interconnected nodes that are organized in a hierarchy that has multiple levels. In various embodiments, the decision tree generation module 106 may construct the decision tree structure 142 based on the request data 140 included in the request 138. For example, consider an instance in which the request 138 (e.g., an API request) from the client device 130 includes a data value for a particular parameter. In such an embodiment, the decision tree generation module 106 may construct the decision tree structure 142 such that the highest level of the hierarchy of interconnected nodes corresponds to the particular parameter specified in the request 138. As explained in greater detail below, constructing the decision tree structure 142 in this way may reduce (often significantly) the number of “paths” through the decision tree structure 142 that may be traversed for the request 138, which, in turn, may greatly reduce the amount of data that will need to be retrieved to evaluate the request 138 using the decision tree structure 142.

Once generated, the decision tree server 104 may send the decision tree structure 142 to the application 122. In the depicted embodiment, application 122 includes decision engine 124, which, in various embodiments, is operable to use the decision tree structure 142 to determine whether, or how, to perform the operation requested by client device 130. Note that, in various embodiments, the decision tree structure 142 generated by decision tree generation module 106 may include information indicative of a set of one or more logical tests to be applied (e.g., by decision engine 124) to evaluate the request 138 in accordance with the appropriate policy for the requested operation. For example, as noted above, a policy may specify multiple different logical tests to apply based on various conditions (that is, the policy may specify multiple different logical tests for the different paths through the decision tree representation of the policy). In various embodiments, as described below with reference to FIGS. 2A-2B, the decision tree structure 142 may include, as leaf nodes in the various paths through the decision tree structure 142, logical tests to apply in evaluating the respective paths. Accordingly, in various embodiments, the decision tree structure 142 sent to the decision engine 124 may include (or otherwise indicate) a set of one or more such logical tests for the possible paths through the reconstructed decision tree for the policy that may be traversed in evaluating the request 138. (Stated differently, in some embodiments, the decision tree structure 142 may not include one or more conditionals or logical tests for those paths, through the decision tree, which will not be taken during evaluation of the request 138.) In some embodiments, the decision tree structure 142 may include code snippets (e.g., one or more nested conditional or logical statements) provided in any suitable programming or scripting language (e.g., Java, JavaScript, Python, etc.). In other embodiments, the decision tree structure 142 may include one or more pointers to locations within the server system 102 from which such code snippets may be retrieved. Further note that, in some embodiments, the logic may take the form of an action rule and may be defined using a rule-specific construct.

In various embodiments, the decision engine 124 may use the decision tree structure 142 to retrieve the user data 144 necessary to evaluate the request 138. In the depicted embodiment, server system 102 further includes data storage device 150 that includes user data stores 109A-109N, which may be used to store data corresponding to various users of the services provided by the server system 102. In the non-limiting embodiment of FIG. 1, for example, the user data store 109A may include data associated with an account with the server system 102 for the user 136 that sent the request 138. In some embodiments, the decision engine 124 may identify a subset of paths through the decision tree structure 142 for which to retrieve user data 144. In some such embodiments, the decision engine 124 may identify these subsets of paths based on the request data 140 that was included in the request 138, as explained in more detail below with reference to FIG. 3C. In various embodiments, the decision engine 124 may then retrieve (e.g., from user data store 109A) the data needed to evaluate the conditions along the possible paths through the decision tree structure 142 that may be taken for the request 138. For example, using the decision tree structure 142 and the request data 140, the decision engine 124 may identify all of the possible paths through the decision tree that may be taken in evaluating the request 138. The decision engine 124 may then identify all of the data needed to evaluate these identified paths and, from that, determine which item(s) of data are needed that are not already specified as part of request data 140. After decision engine 124 has loaded this data (e.g., from user data store 109A) and during the actual execution of the logical tests, any one of these possible paths may be evaluated, for example to determine whether or how to perform the requested operation.

Once it has obtained the requisite data, the decision engine 124 may use this data to evaluate the request 138 using the decision tree structure 142. For example, in some embodiments, the decision engine 124 may determine whether to authorize the request 138 to perform a particular operation using the decision tree structure 142 and the retrieved user data 144. If the decision engine 124 determines, based on its evaluation of the decision tree structure 142, that the requested operation is authorized, application 122 may initiate performance of the requested operation. If, however, the decision engine 124 determines that the requested operation is not authorized, server system 102 may take one or more appropriate actions, such as requiring additional authentication operations by the user 136. In various embodiments, the application 122 may provide a response 146, to the client device 130, that may include, if the requested operation is determined to be authorized, the results or confirmation of the request operation or, if the requested operation is determined not to be authorized, an indication that the requested operation could not be performed.

Note that, in various embodiments, in addition to (or instead of) generating the decision tree structure 142 at runtime, the decision tree generation module 106 may generate one or more decision tree structures for a given policy preemptively such that, at runtime, the appropriate decision tree structure for the given policy may simply be retrieved and provided to the application 122. For example, in the embodiment depicted in FIG. 1, the decision tree server 104 includes decision tree repository 110. In some embodiments, once it has generated the decision tree structure 142, either preemptively or in response to a request 139, the decision tree generation module 106 may store the decision tree structure 142 in the decision tree repository 110 for future use. In such embodiments, when the decision tree server 104 subsequently receives a decision tree request 139 from application 122, it may first check to see whether an appropriate decision tree structure 142 is already stored in the decision tree repository 110. If so, the decision tree generation module 106 may retrieve that decision tree structure 142 from the repository 110 and provide it to the requesting application 122 and, if the desired decision tree structure is not already present in the repository 110, the decision tree generation module 106 may dynamically generate the decision tree structure 142 as described herein.

Storing and dynamically retrieving decision tree structures 142 may provide various technical benefits. For example, in instances in which a policy includes a large number of rules or conditions such that the resulting decision tree structures 142 typically have a large number (e.g., 10,000 or more) possible paths, dynamically generating the decision tree structures 142 at runtime may be a time-intensive task. Accordingly, in some embodiments, the decision tree server 104 may maintain, for a given policy, one or more corresponding decision tree structures 142 in the repository. In some such embodiments, for example, the decision tree server 104 may monitor, for the given policy, the types of request data 140 (e.g., the parameter(s)) included in the decision tree requests 139 and the usage of the different decision tree structures 142. In doing so, the decision tree server 104 may determine which of the decision tree structures 142 are most frequently used for the policy and retain all or some (e.g., 5, 10, 50, etc.) of those structures 142 in the repository 110, which may reduce the time required to provide those decision tree structures 142 to the requesting application 122. In some embodiments, the particular decision tree structures 142 that are retained in the repository 110 may be periodically audited to adapt to shifts in patterns of usage so as to retain the most frequently used (or most computationally demanding to generate) decision tree structures 142. Note that, in some embodiments, the decision tree structures 142 stored in repository 110 may be preemptively generated (that is, independent of any decision tree request 139) or may be generated dynamically in response to a decision tree request 139. Further note that, in some embodiments, the decision tree structures 142 stored in the repository 110 may be tagged with an identifier to facilitate faster retrieval. In some such embodiments, these tags may be based on (or indicative of) the ordering of the levels in the decision tree structures 142, the parameter(s) included in request data 140, etc.

Further note that, although discussed herein in the context of determining whether to authorize a requested operation, the disclosed techniques may be used in various different contexts. Broadly speaking, the disclosed techniques may be used in any context in which a decision tree structure is used to evaluate information to reach a decision. As one non-limiting example, consider an instance in which server system 102 hosts a “chatbot” service designed to engage in a conversation (e.g., through an instant messenger-style interface) with human users. In such an embodiment, the server system 102 may utilize a dialog tree to determine the appropriate responses to provide based on a statement or “utterance” by the user. In many instances, such dialog trees may be large and complex, having many possible paths that may be taken in making this response determination. In various embodiments, the disclosed techniques may be used to dynamically construct dialog policy decision trees for such a chatbot system in a manner that reduces the amount of data that needs to be retrieved to evaluate the dialog policy.

Turning now to FIGS. 2A-2B, block diagrams 200 and 250 respectively depict two example decision tree structures 142A and 142B corresponding to the same policy used to determine whether, or how, to perform a requested operation. More specifically, decision tree structures 142A and 142B correspond to the written policy provided above that may be used, in instances in which the server system 102 provides an online payment service, to determine whether to authorize a transfer of funds between users. Note that, while both decision tree structures 142 may be used to implement the same policy, their respective structures differ. As noted above, it may be advantageous to use different decision tree structures 142 for a given policy depending on the request data 140 included in a given request 138 to perform a computing operation.

Referring to FIG. 2A, decision tree structure 142A includes a set of nodes arranged in a hierarchy with multiple levels L1-L4. In various embodiments, the levels in a decision tree structure 142 may correspond to the different conditions (or “keys”) specified in a key-value representation of a policy. In the depicted embodiment, the decision tree structure 142A includes two nodes on the highest level (L1) of the hierarchy—a node labeled “Send” and a node labeled “Receive.” In various embodiments, the levels in a decision tree structure 142 may correspond to the conditions used in the rules of the policy. Stated differently, for a rule with multiple conditions, a corresponding decision tree structure 142 may include multiple levels, one for each of the conditions, according to some embodiments. In the non-limiting embodiment depicted in FIGS. 2A-2B, for example, the rules in the policy include a condition that tests whether the requesting user is the “sender” or “receiver” in the request to transfer funds. The generation of the decision tree structures is described in more detail below with reference to FIG. 3C. Note that the decision tree generation module 106 may create, on a level corresponding to a given condition, a node for each of the available values for the given condition. For example, in FIG. 2A, a requesting user may either be a “sender” or “receiver” of funds in the requested transfer, so the decision tree generation module 106 may create a node for each of these available values in the level of the decision tree structure 142 corresponding to this condition.

In FIG. 2A, the nodes in the first level are connected to a set of nodes in a second level (L2) of the decision tree structure 142A. More specifically, the “Send” node in L1 is connected to one node labeled “US” and one node labeled “EU” and the “Receive” node in L1 is similarly connected to one node labeled “US” and one node labeled “EU.” Referring again to the example policy above, one condition included in the set of rules asks whether the requesting user is a citizen of the US or of an EU-member country. Since there are two available values for this particular condition, the decision tree generation module 106, in the depicted embodiment, may generate a node for each of the available values. Similarly, the nodes in the second level (L2) are connected to a set of nodes in a third level (L3), which, in turn, are connected to a set of nodes in a fourth level (L4). Note that, in the depicted embodiment, the nodes in the final layer (the “leaf” nodes) refer to a logical test (e.g., consisting of one or more logical or conditional statements) applied in an instance in which the evaluation of a request 138 leads down a path through the decision tree structure 142 that ends with the particular leaf node.

Thus, in the example decision tree structure 142A of FIG. 2A, each of the conditions in the policy is represented by a level in the tree. More specifically, the highest level corresponds to whether the requesting user is a “sender” or “receiver,” the second level corresponds to the citizenship of the requesting user, and the third level corresponds to the type of financial instrument to be used in the transfer. As discussed herein, however, multiple different, logically equivalent decision tree structures 142 may often be generated for a given policy. For example, FIG. 2B depicts an alternative decision tree structure 142B that may be generated for the example policy. Like decision tree structure 142A, decision tree structure 142B also includes interconnected nodes arranged into a hierarchy having multiple levels. As shown in FIG. 2B, however, the order of the levels, the nodes in a given level, and the manner in which the nodes are connected in decision tree structure 142B differ from decision tree structure 142A of FIG. 2A. For example, in decision tree structure 142B, the highest level corresponds to the financial instrument to be used, the second level corresponds to whether the requesting user is a “sender” or “receiver” of funds, and the third level corresponds to the citizenship of the requesting user. In decision tree structure 142B, like decision tree structure 142A, the fourth level includes a set of leaf nodes referring to logical tests to apply when a given leaf node is reached.

In some instances, it may be desirable for the decision engine 124 to utilize one of decision tree structures 142A-142B over the other. For example, consider an instance in which the request 138 specifies that the requested operation is to perform a transfer of funds and that the financial instrument to be used is a credit card, but does not specify any additional information that is to be used when using the decision tree structure 142 to determine whether or how to perform the requested operation. In such an instance, if decision tree structure 142A were used to evaluate this request 138, there would be 10 nodes (denoted using asterisks in FIG. 2A) taken under consideration. Using decision tree structure 142B to evaluate this request 138, however, only 7 nodes (again denoted using asterisks in FIG. 2B) would be taken under consideration, thereby reducing the amount of data that would need to be fetched (e.g., from persistent storage, which may be relatively slow) to evaluate the request 138. Note that this simple example is provided merely for the purposes of illustration. Even in this simple example, however, the disclosed techniques of dynamically generating a decision tree structure 142B based on the parameters specified in the request 138 reduce the number of nodes for which data needs to be retrieved by 30%. In many instances, the policy for a given operation may be significantly longer or more complicated than that in the running example and, as such, the corresponding decision tree structures 142 that may be generated for that policy may also be significantly larger and more complex than those shown in FIGS. 2A-2B. For example, a decision tree structure 142 may include hundreds or thousands of unique paths through the tree. In instances in which the disclosed techniques are utilized to dynamically generate these larger decision tree structures 142, the technical benefits of the disclosed techniques may similarly be significantly greater than that shown in the depicted example, dramatically reducing the amount of data that needs to be retrieved by the decision engine 124, saving computational time and resources, and improving the speed with which the server system 102 may provide its various web services to end users.

Turning now to FIG. 3A, diagram 300 depicts an example request 138 that may be sent by client device 130 to request that application 122 perform a particular operation. For example, in the depicted embodiment, request 138 is an API request that may be sent to an API endpoint URI associated with the application 122. Request 138 may include various components. In the depicted embodiment, request 138 includes an operation identifier 302 and request data 140. In various embodiments, the operation identifier 302 may be an API name associated with the requested operation and the request data 140 may include one or more data values for one or more parameters defined for the API. For instance, in the depicted embodiment, the operation identifier 302 provided is “transfer,” indicating that the requested operation is to transfer funds between users, and the request data 140 includes one data value (e.g., “cc”) for one parameter (e.g., “instrument”), indicating that the requested operation is to perform a transfer of funds using a credit card as the financial instrument. Note, however, that this embodiment is provided merely as one non-limiting example. In other embodiments, server system 102 may provide any of various suitable web services and the request 138 may include any suitable combination of request data 140.

In various embodiments, the disclosed techniques may include using the information included in the request 138 to dynamically generate a decision tree structure 142 for that request 138. As noted above, the decision tree structure 142 may be generated based on a key-value representation of a policy established for the requested operation. Referring now to FIG. 3B, diagram 310 depicts an example key-value representation 316 of the policy in the running example described above. In the depicted embodiment, the key-value representation 316 of the policy includes three conditions 312 and multiple available values 314 associated with each of the conditions 312. More specifically, in the depicted embodiment, the conditions 312 include “citizenship,” which may take as an available value either “US” or “EU,” “intent,” which may take as an available value either “sender” or “receiver,” and “instrument,” which may take as an available value either “cc,” “ACH,” “PAD,” or “ECheck.” Note that this embodiment is provided merely as one non-limiting example, however, and in other embodiments, a policy may include any number of rules that utilize potentially numerous (e.g., hundreds, thousands, etc.) of conditions 312, each of which may have multiple available values 314. Further note that, in some embodiments, a given condition 312 may appear in some, all, or none of the rules in a policy. That is, in some embodiments, there may be a rule that utilizes a particular condition 312A that is not utilized in one or more of the other rules in the policy.

Note that, in various embodiments, the parameters in the request data 140 may correspond to one or more of the conditions 312 in the key-value representation 316 of the policy. That is, in some embodiments, the API associated with the requested operation (and, as such, associated with the key-value representation 316 of the policy used to evaluate whether or how to perform that operation) may be designed in such a manner so as to allow (or require) the API calls to include one or more parameters that correspond to one or more conditions 312. Further note that, in various embodiments, the decision tree structure 142 may be constructed such that the levels in the tree correspond to the conditions 312 in the key-value representation 316, where a level for a given condition 312 includes one or more nodes for each available value 314 associated with that condition 312. As noted above, a key-value representation 316 may be used to construct multiple different, though logically equivalent, decision tree structures 142 that may be used to implement a policy.

Additionally, as noted above, it may be advantageous to dynamically construct a decision tree structure 142 for a request 138 based on the request data 140 (e.g., parameters for which a data value is provided) specified in the request 138 so as to reduce the amount of data that must be retrieved to evaluate the request 138. For example, referring to FIG. 3C, diagram 320 depicts an example decision tree structure 142B that may be generated by the decision tree generation module 106 for the request 138 shown in FIG. 3A. As shown in FIG. 3C, decision tree structure 142B is organized such that its highest level corresponds to the “instrument” condition 312 and includes a node for each of the available values 314 that this condition may take. In the depicted embodiment, the decision tree generation module 106 may detect that a data value is provided for the “instrument” parameter in the request 138 and, based on this, construct the decision tree structure 142B such that the highest level in the hierarchy of nodes corresponds to this parameter. As noted above, constructing the decision tree structure 142B in this manner may reduce the number of potential paths that may be taken through the decision tree structure 142 when evaluating the request 138, thereby reducing the amount of data that needs to be retrieved to evaluate the request 138. Stated differently, dynamically generating the decision tree structure 142 may improve the decision engine 124′s ability to more accurately predict the path through the decision tree that will actually be taken at runtime, reducing the possible number of paths and nodes for which data needs to be retrieved. For example, in the depicted embodiment, there are only two possible paths (bolded, for reference) through the decision tree structure 142B that may be taken for the request 138 since it is known that the requested transfer operation involves a credit card as the financial instrument (as indicated in the request data 140). As such, in this non-limiting example, when evaluating the request 138, the decision engine 124 would only need to retrieve data that is utilized by the nodes along these two paths before the actual execution of the condition flow.

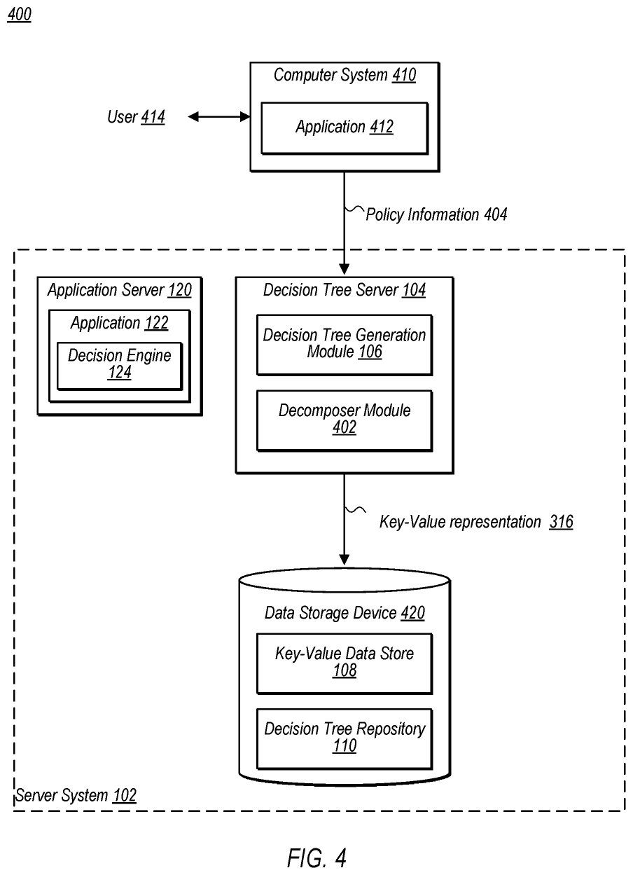

In various embodiments, the disclosed techniques may enable users associated with the server system 102 (e.g., software developers, policy team members, etc.) to provide information corresponding to a policy, which may then be converted into a key-value representation 316 of that policy for subsequent use in dynamically generating decision tree structures 142. For example, referring now to FIG. 4, block diagram 400 depicts a server system 102, which includes application server 120, data storage device 420, and decision tree server 104. Further, in the depicted example, block diagram 400 depicts a user 414 accessing a computer system 410, shown executing an application 412 (e.g., a web browser) that the user 414 may use to specify the policy information 404. In various embodiments, the user 414 may provide policy information 404 that is associated with an operation that may be performed by an application 122 hosted by the server system 102. For example, in some embodiments, the policy information 404 may include one or more policy rules provided as text using any suitable structured or unstructured format (e.g., an email, text document, entered through a web form, etc.). In some such embodiments, the rules included in the policy information 404 may include various conditions against which a given request may be evaluated. For the example policy provided above, for instance, the policy information 404 may specify the eight given policy rules associated with operation of transferring funds between users. Additionally, in various embodiments, the policy information 404 may identify one or more operations for which the policy is to be implemented (e.g., using an operation identifier or name, an identifier of the relevant application 122, etc.).

In various embodiments, the disclosed techniques are operable to generate a key-value representation 316 of the policy based on this policy information 404. For example, in the depicted embodiment, decision tree server 104 includes decomposer module 402, which, in various embodiments, is operable to generate a key-value representation 316 of the policy based on the policy information 404. In some embodiments, for example, the decomposer module 402 may parse the policy information to identify the various conditions 312, and available values 314 for those conditions 312, specified by the rules in policy information 404. Note that, in some embodiments, rather than providing text describing a policy, the policy information 404 may include a decision tree structure 142 for a policy. That is, in some embodiments, the user 414 may provide information indicative of one possible decision tree structure 142 for a policy associated with a particular operation and, using this information, the decomposer module 402 may parse this decision tree structure 142 to identify various aspects of its content and structure, such as the conditions 312 with which the levels are associated, the available values 314 represented by nodes in the tree structure, the relationship between conditions 312, the relationships between levels of the tree, etc., and may generate a key-value representation 316 for the policy. For example, in some embodiments, the parsing is performed based on one or more defined tokens or key values. In some embodiments, for example, parsing may include decomposing the policy information 404 and analyzing the various conditions and relations between nodes. Once generated, the key-value representation 316 may be stored in the key-value data store 108 for future use in dynamically constructing decision tree structures 142 based on request data 140, as described herein.

### Example Methods

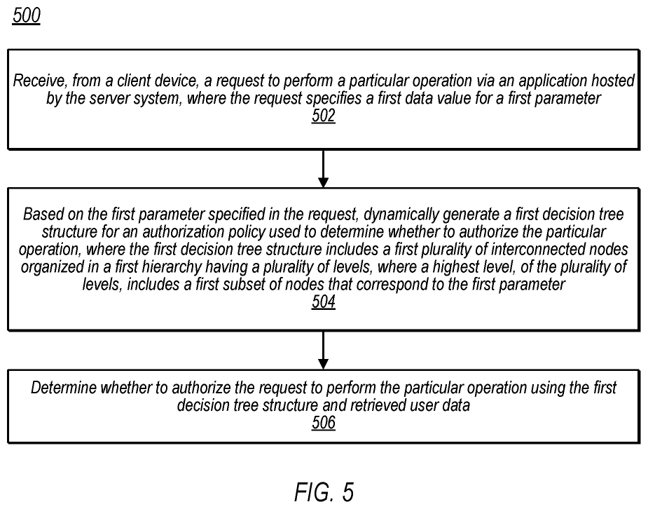

Referring now to FIG. 5, a flow diagram illustrating an example method 500 for dynamically generating a decision tree structure is depicted, according to some embodiments. In various embodiments, method 500 may be performed by one or more elements included in server system 102 of FIG. 1, such as decision tree generation module 106 or decision engine 124, to dynamically generate a decision tree structure and use that decision tree structure to determine whether to authorize a requested operation. For example, server system 102 may include (or have access to) a non-transitory, computer-readable medium having program instructions stored thereon that are executable by one or more computing devices in the server system 102 to cause the operations described with reference to FIG. 5. In FIG. 5, method 500 includes elements 502-506. While these elements are shown in a particular order for ease of understanding, other orders may be used. In various embodiments, some of the method elements may be performed concurrently, in a different order than shown, or may be omitted. Additional method elements may also be performed as desired.

At 502, in the illustrated embodiment, the server system receives, from a client device, a request to perform a particular operation via an application hosted by the server system. For example, as described above with reference to FIG. 1, the server system 102 may receive a request 138, from the client device 130, for application 122 to perform a particular operation. In the depicted embodiment, the request specifies a first data value for a first parameter. For example, the request 138 may include one or more items of request data 140, which may be specified as data values for parameters in an API request.

At 504, in the illustrated embodiment, the server system, based on the first parameter specified in the request, dynamically generates a first decision tree structure for an authorization policy used to determine whether to authorize the particular operation. In various embodiments, the first decision tree structure may include a first plurality of interconnected nodes organized in a first hierarchy having a plurality of levels, where a highest level, of the plurality of levels, includes a first subset of nodes that correspond to the first parameter. For example, as described above in reference to FIG. 1, in some embodiments, dynamically generating the first decision tree structure may include, in response to the request 138, retrieving a key-value representation of an authorization policy that specifies a plurality of conditions used to evaluate a given request to perform the particular operation.

Further, in the depicted embodiment, the first parameter specified in the request 138 may correspond to a first one of the plurality of conditions. In some such embodiments, the key-value representation may include, for the first condition, a first plurality of available values. Additionally, in some embodiments, dynamically generating the first decision tree structure may further include detecting that the first parameter is specified in the request 138, selecting, from the key-value representation of the authorization policy, the first condition to correspond to a highest level of the first decision tree structure 142, and creating the first subset of nodes, in the highest level of the first decision tree structure, based on the first plurality of available values for the first condition. (Note that, in some embodiments, the request 138 may include data values for multiple different parameters. Further note that, in some embodiments, the multiple different parameters specified (e.g., as part of the request data 140) in the request 138 may correspond to multiple different conditions 312 in the key-value representation 316 of the policy for the requested operation. Accordingly, in some embodiments, dynamically generating the first decision tree structure may include optionally be performed based on all (or any desired subset) of the parameters in the request 138 for which there is a corresponding condition 312 in the key-value representation 316 of the policy.)

Note that, in some embodiments, the disclosed techniques may generate the decision tree structures 142 based on the request data 140 so as to reduce the complexity of the resulting decision tree structure 142. For example, in the depicted embodiment, the result data 140 includes a first data value for a first parameter and, as such, the decision tree generation module 106 determines that the highest level in the structure 142 will correspond to this first parameter. In some such embodiments, since the request data 140 specifies the first data value for this first parameter, the decision tree generation module 106 may generate only the portion of the decision tree structure 142 that passes through a first node that corresponds to the first data value for the first parameter. In this way, the disclosed techniques may avoid generating (potentially large) portions of the decision tree structure 142 that are not going to be utilized in evaluating the current request 138 to perform the particular operation. This, in turn, may save computational time and resources.

At 506, in the illustrated embodiment, the server system determines whether to authorize the request to perform the particular operation using the first decision tree structure and retrieved user data. For example, in various embodiments, the server system 102 may identify, based on the first decision tree structure 142, a subset of paths through the first decision tree structure 142 for which to retrieve the user data 144 for the request 138. In various embodiments, to identify the subset of paths, the server system 102 may identify a first node on the highest level in the first decision tree structure that corresponds to the first data value for the first parameter, where the subset of paths through the decision tree structure depend on the first node.

In various embodiments, once generated, the server system 102 may store one or more decision tree structures 142 for subsequent use. For example, in some embodiments, subsequent to the dynamically generating the first decision tree structure, the server system 102 may store the first decision tree structure 142 in a decision tree repository 110 that is accessible to the server system 102. In some such embodiments, method 500 may further include receiving a second request to perform the particular operation, where the second request specifies a second data value for the first parameter. In response to the second request, the server system may retrieve the first decision tree structure from the repository and determine whether to authorize the second request to perform the particular operation using the first decision tree structure.

As noted above, in various embodiments, the disclosed techniques may include generating multiple different decision tree structures for the same policy, depending on the information included in a given request to perform an operation associated with the policy. For example, in some embodiments, method 500 may include receiving, by the server system 102, a third request to perform the particular operation, where the third request specifies a third data value for a second parameter. Based on this third request, the server system may dynamically generate a second, different decision tree structure for the authorization policy, where a highest level of the second decision tree structure includes a second plurality of nodes corresponding to the second parameter. In such embodiments, the server system may, based on the second decision tree structure, identify a second subset of paths through the second decision tree structure for which to retrieve second user data and, based on the second user data, determine whether to authorize the third request using the second decision tree structure. In some such embodiments, method 500 may further include the server system storing the second decision tree structure in the repository and monitoring the usage of the first and second decision tree structures over a particular time period (e.g., one week, one month, six months, one year, etc.). The server system 102 may then determine whether to retain the first and second decision tree structures in the repository based on their respective usages.

Further, in various embodiments, method 500 may include the server system preemptively generating one or more decision tree structures for subsequent use in determining whether to authorize a requested operation. For example, in some embodiments, the server system may generate a third decision tree structure for the authorization policy, where the highest level of the third decision tree structure includes a third plurality of nodes corresponding to a third parameter. In some such embodiments, subsequent to generating the third decision tree structure, the server system may receive a fourth request to perform the particular operation. Based on the third decision tree structure, the server system may identify a third subset of paths through the third decision tree structure for which to retrieve third user data and, using the third decision tree structure and third user data, determine whether to authorize the fourth request to perform the particular operation.

Additionally, in some embodiments, the disclosed systems capable of generating a key-value representation for a policy based on information provided by a user, as described in more detail above with reference to FIG. 4. For example, some embodiments, method 500 may include receiving policy information indicative of the authorization policy, where the policy information specifies one or more policy rules associated with the particular operation. In some such embodiments, method 500 may include parsing the policy information to generate the key-value representation of the authorization policy, where the key-value representation specifies a plurality of conditions that are used to evaluate a given request to perform the particular operation.

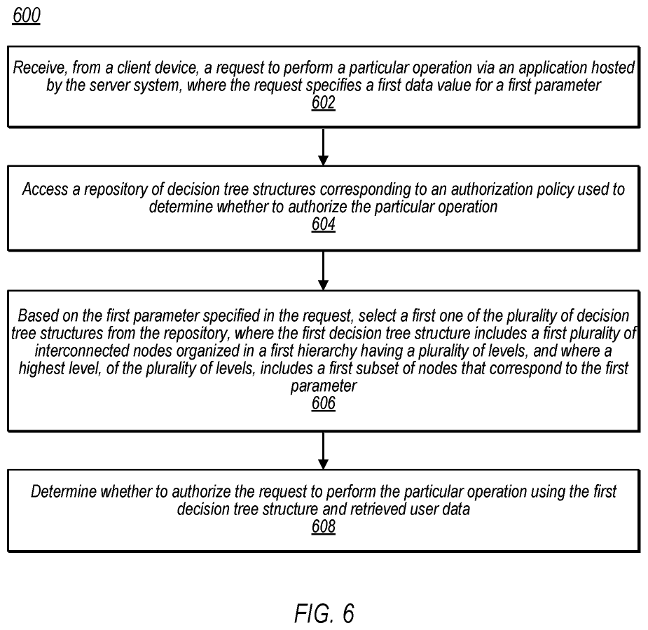

Turning now to FIG. 6, a flow diagram illustrating an example method 600 for retrieving a decision tree structure based on information included in a request is depicted, according to some embodiments. In various embodiments, method 600 may be performed by one or more elements included in server system 102 of FIG. 1, such as decision tree generation module 106 or decision engine 124, to dynamically retrieve a decision tree structure and use that decision tree structure to determine whether to authorize a requested operation. For example, server system 102 may include (or have access to) a non-transitory, computer-readable medium having program instructions stored thereon that are executable by one or more computing devices in the server system 102 to cause the operations described with reference to FIG. 6. In FIG. 6, method 600 includes elements 602-608. While these elements are shown in a particular order for ease of understanding, other orders may be used. In various embodiments, some of the method elements may be performed concurrently, in a different order than shown, or may be omitted. Additional method elements may also be performed as desired.

At 602, in the illustrated embodiment, the server system receives a request to perform a particular operation via an application hosted by the server system, where the request specifies a first data value for a first parameter. For example, server system 102 may receive a request 138 from user 136 of client device 130 to perform an operation provided by the application 122 hosted by the server system 102.

At 604, in the illustrated embodiment, the server system accesses a repository of decision tree structures corresponding to an authorization policy that is used to determine whether to authorize the particular operation. For example, in response to the request 138, the decision engine 124 or application 122 may send a decision tree request 139 to the decision tree server 104 requesting a decision tree structure 142 that may be used to determine whether to authorize the requested operation. Using information contained in this decision tree request 139, the decision tree server 104 may, in some embodiments, access a decision tree repository 110 stored in a data storage device included in (or otherwise accessible to) the server system 102. As noted above, in various embodiments, the decision tree repository 110 may include multiple previously generated decision tree structures corresponding to one or more policies (e.g., authorization policies) that may be used by one or more application 122 in the server system 102 to dictate whether, or how, requested operations are performed.

At 606, in the illustrated embodiment, the server system selects, based on the first parameter specified in the request, a first one of the plurality of decision tree structures from the repository. In some such embodiments, the first decision tree structure includes a first plurality of interconnected nodes organized in a first hierarchy having a plurality of levels, where a highest level includes a first subset of nodes that correspond to the first parameter. As noted above, in various embodiments, when the decision tree structures 142 are generated and stored in the repository 110, they may be assigned an identifier corresponding to the “use case” for which they were generated (e.g., the sequence of levels in the hierarchy, the parameter(s) in the request 139 for which the structure 142 was generated, etc.). In various embodiments, element 606 may include selecting the first decision tree structure from the repository 110 using these identifiers based on the request data 140 included in the request 139. Further, in some embodiments, repository 110 may include multiple decision tree structures 142 that may potentially be used to evaluate a given request 138. In some such embodiments, the decision tree server 104 may return multiple decision tree structures 142 to the application 122, which may then determine which to use in evaluating the request 138, for example based on the number of paths required by the different structures 142 to evaluate the request 138.

At 608, in the illustrated embodiment, the server system determines whether to authorize the request to perform the particular operation using the first decision tree structure and retrieved user data. For example, in some embodiments, method 600 may further include identifying, based on the first decision tree structure, a subset of paths through the first decision tree structure for which to retrieve the user data for the request. In some such embodiments, identifying the subset of paths may include identifying a first node on the highest level of the first decision tree that corresponds to the first data value for the first parameter, where the subset of paths through the first decision tree structure depend on the first node.

Further, in some embodiments, method 600 may include the server system receiving a second request to perform the particular operation, where the second request specifies a second data value for a second parameter. Based on this second parameter specified in the second request, the server system may select a second one of the plurality of decision tree structures from the repository, where the second decision tree structure includes a second plurality of interconnected nodes organized in a second hierarchy having a second plurality of levels and where, in a highest of the levels in the second decision tree structure, there are a second subset of nodes that correspond to the second parameter. In some such embodiments, the server system may determine whether to authorize the second request to perform the particular operation using the second decision tree structure.

Note that, in some embodiments of method 600, in addition to retrieving an appropriate decision tree structure 142 (e.g., at runtime) to determine whether to authorize a requested operation, the server system 102 may also dynamically generate one or more decision tree structures at runtime based on the request data 140 included in the request 138 from the client device 130. For example, in some embodiments, method 600 may further include the server system receiving a second request to perform the particular operation, where the second request specifies a second data value for a second parameter. In some embodiments, however, the decision tree repository 110 may not already have an appropriate or optimal decision tree structure for the policy corresponding to the requested operation. In such embodiments, method 600 may include the server system determining that the repository does not include, for the authorization policy, a second decision tree structure in which a highest level of the second decision tree structure corresponds to the second parameter. In some such embodiments, the server system may dynamically generate the second decision tree structure based on the second parameter specified in the second request and, using the second decision tree structure, determine whether to authorize the second request to perform the particular operation. For example, in some embodiments, dynamically generating the second decision tree structure may include retrieving a key-value representation of the authorization policy that specifies a plurality of conditions used to evaluate a given request to perform the particular operation. In some such embodiments, the second parameter specified in the second request may correspond to a particular one of the plurality of conditions and the key-value representation for the authorization policy may include, for the particular condition, a plurality of available values. In some embodiments, the server system may then select, from the key-value representation of the authorization policy, the particular condition to correspond to the highest level of the second decision tree structure and create the second subset of nodes, in the highest level of the second decision tree structure, based on the plurality of available values for the particular condition.

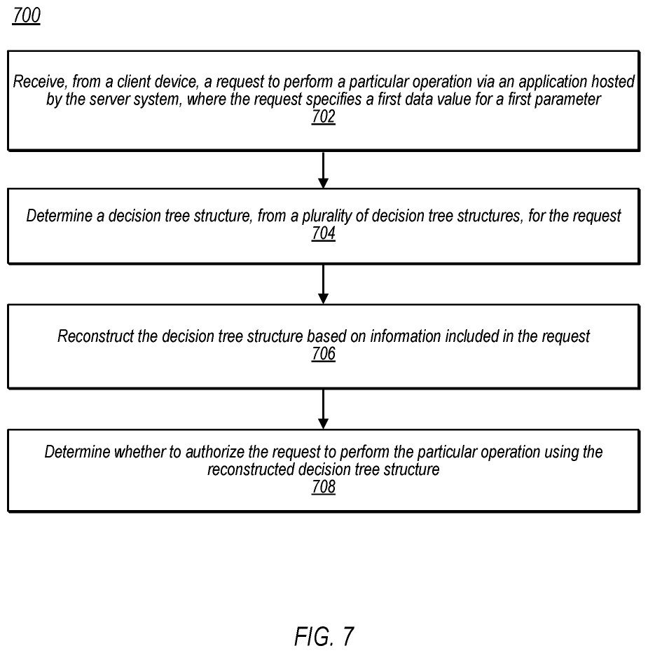

Referring now to FIG. 7, a flow diagram illustrating an example method 700 for dynamically reconstructing a decision tree structure is depicted, according to some embodiments. In various embodiments, method 700 may be performed by decision tree server 104 of FIG. 1 to dynamically reconstruct a decision tree structure 142. For example, decision tree server 104 may include (or have access to) a non-transitory, computer-readable medium having program instructions stored thereon that are executable by one or more computing devices in the server system 102 to cause the operations described with reference to FIG. 7. In FIG. 7, method 700 includes elements 702-708. While these elements are shown in a particular order for ease of understanding, other orders may be used. In various embodiments, some of the method elements may be performed concurrently, in a different order than shown, or may be omitted. Additional method elements may also be performed as desired.

At 702, in the illustrated embodiment, the server system receives, from a client device, a request to perform a particular operation via an application hosted by the server system. For example, user 136 may send, via client device 130, a request 138 to perform a particular operation via application 122 hosted by application server 120. As noted above, in some embodiments the request 138 may include an API request sent to an endpoint URI associated with the application 122 and may include data values for one or more parameters, as required or permitted by the API. Upon receiving this request 138, application 122 may send a decision tree request 139, along with one or more items of request data 140 included in the initial request 138, to decision tree server 104.

At 704, in the illustrated embodiment, the decision tree server determines a decision tree structure, from a plurality of decision tree structures, to use for the request. As noted above, in various embodiments the decision tree server 104 may be operable to dynamically reconstruct many different decision tree structures 142 corresponding to many different operations offered by the application 122 (or other applications hosted within the server system 102). Accordingly, in some embodiments, the application 122 may include, in the request data 140, an identifier for the particular operation of the application 122 being requested (e.g., by the user device 130). Based on this information, the decision tree server 104 may determine the appropriate decision tree structure to provide to the requesting application 122. For example, in some embodiments, the decision tree server 104 may access a decision tree repository 110, which may include key-value representations 316 of policies corresponding to various operations performable by the application 122. Using the identifier of the requested operation, the decision tree server 104 may retrieve the key-value representation 316 for a policy associated with the requested operation.

Additionally, at element 704, the decision tree server 104 may use one or more other items of information to determine, based on the key-value representation 316, the appropriate decision tree structure 142, of multiple different decision tree structures that could be reconstructed for the requested operation, to return to the application 122. That is, as noted above, decision tree server 104 may be operable to reconstruct multiple different decision tree structures 142 based on a single key-value representation 316 of a policy for a requested operation, where the different decision tree structures 142 are structured differently and may be more advantageous (e.g., to reduce the amount of data to be pre-fetched) in different situations. In various embodiments, at 704, the decision tree server 104 may determine, based on the information included in the request 139, which of the multiple potential decision tree structures 142 to reconstruct for the requested operation. Referring again to the non-limiting embodiment of FIGS. 3A-3C, if the request 139 to the decision tree server 104 identifies the requested operation as a “transfer” and that the financial instrument involved is a “credit card,” the decision tree server 104 may determine that the decision tree structure 142 that is most appropriate for the requested operation is one in which the level corresponding to the “financial instrument” condition is positioned at (or near) the top of the decision tree structure 142.

At 706, in the illustrated embodiment, the decision tree server reconstructs the decision tree structure based on information included in the request. In various embodiments, the request data 140 may include various items of information usable by the decision tree server 104 to determine how to reconstruct the decision tree structure 142. For example, based on the request data 140, the decision tree server 104 may identify one or more parameters for which a data value is specified and reconstruct the decision tree structure 142 such that at least one of the levels higher up in the structure (e.g., the highest level) corresponds to a parameter for which a data value is provided in the request data 140. As discussed in detail above, reconstructing the decision tree structure 142 in such a manner may reduce the number of paths for which user data (e.g., corresponding to the user 136) may need to be retrieved in order to evaluate the decision tree structure 142 and determine whether (or how) to perform the requested operation. The decision tree server may reconstruct the decision tree structure 142 using a key-value representation 316 of a policy associated with the requested operation, as described in detail above with reference to FIGS. 2A-2B and 3A-3C.

At 708, in the illustrated embodiment, the server system determines whether to authorize the request to perform the particular operation using the decision tree structure and retrieved user data. For example, in various embodiments, the server system 102 may identify, based on the decision tree structure 142 provided by the decision tree server 104, a subset of paths through the first decision tree structure 142 for which to retrieve the user data 144. In various embodiments, the decision engine 124 may then retrieve (e.g., from user data store 109) the data needed to evaluate the conditions along the possible paths through the decision tree structure 142 that may be taken for the request 138. Once it has obtained the requisite data, the decision engine 124 may use this data to evaluate the request 138 using the decision tree structure 142. For example, in some embodiments, the decision engine 124 may determine whether to authorize the request 138 to perform a particular operation using the decision tree structure 142 and the retrieved user data 144. If the decision engine 124 determines, based on its evaluation of the decision tree structure 142, that the requested operation is authorized, application 122 may initiate performance of the requested operation. If, however, the decision engine 124 determines that the requested operation is not authorized, server system 102 may take one or more appropriate actions, such as requiring additional authentication operations by the user 136.

### Example Computer System

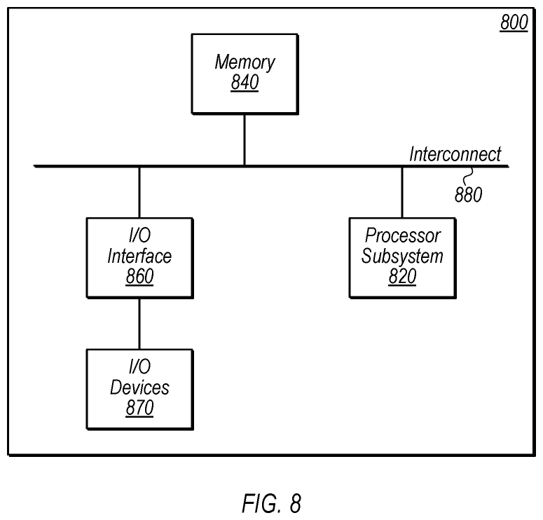

Referring now to FIG. 8, a block diagram of an example computer system 800 is depicted, which may implement one or more computer systems, such as client device 130 or one or more machines included in server system 102 of FIG. 1, according to various embodiments. Computer system 800 includes a processor subsystem 820 that is coupled to a system memory 840 and I/O interfaces(s) 860 via an interconnect 880 (e.g., a system bus). I/O interface(s) 860 is coupled to one or more I/O devices 870. Computer system 800 may be any of various types of devices, including, but not limited to, a server computer system, personal computer system, desktop computer, laptop or notebook computer, mainframe computer system, server computer system operating in a datacenter facility, tablet computer, handheld computer, workstation, network computer, etc. Although a single computer system 800 is shown in FIG. 8 for convenience, computer system 800 may also be implemented as two or more computer systems operating together.

Processor subsystem 820 may include one or more processors or processing units. In various embodiments of computer system 800, multiple instances of processor subsystem 820 may be coupled to interconnect 880. In various embodiments, processor subsystem 820 (or each processor unit within 820) may contain a cache or other form of on-board memory.

System memory 840 is usable to store program instructions executable by processor subsystem 820 to cause system 800 perform various operations described herein. System memory 840 may be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 800 is not limited to primary storage such as system memory 840. Rather, computer system 800 may also include other forms of storage such as cache memory in processor subsystem 820 and secondary storage on I/O devices 870 (e.g., a hard drive, storage array, etc.). In some embodiments, these other forms of storage may also store program instructions executable by processor subsystem 820.

I/O interfaces 860 may be any of various types of interfaces configured to couple to and communicate with other devices, according to various embodiments. In one embodiment, I/O interface 860 is a bridge chip (e.g., Southbridge) from a front-side to one or more back-side buses. I/O interfaces 860 may be coupled to one or more I/O devices 870 via one or more corresponding buses or other interfaces. Examples of I/O devices 870 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 870 includes a network interface device (e.g., configured to communicate over WiFi, Bluetooth, Ethernet, etc.), and computer system 800 is coupled to a network via the network interface device.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

Unless stated otherwise, the specific embodiments described herein are not intended to limit the scope of claims that are drafted based on this disclosure to the disclosed forms, even where only a single example is described with respect to a particular feature. The disclosed embodiments are thus intended to be illustrative rather than restrictive, absent any statements to the contrary. The application is intended to cover such alternatives, modifications, and equivalents that would be apparent to a person skilled in the art having the benefit of this disclosure.

Particular features, structures, or characteristics may be combined in any suitable manner consistent with this disclosure. The disclosure is thus intended to include any feature or combination of features disclosed herein (either explicitly or implicitly), or any generalization thereof. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

For example, while the appended dependent claims are drafted such that each depends on a single other claim, additional dependencies are also contemplated, including the following: Claim 3 (could depend from any of claims 1-2); claim 4 (any preceding claim); claim 5 (claim 4), etc. Where appropriate, it is also contemplated that claims drafted in one statutory type (e.g., apparatus) suggest corresponding claims of another statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to the singular forms such “a,” “an,” and “the” are intended to mean “one or more” unless the context clearly dictates otherwise. Reference to “an item” in a claim thus does not preclude additional instances of the item.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” covering x but not y, y but not x, and both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one of element of the set [w, x, y, z], thereby covering all possible combinations in this list of options. This phrase is not to be interpreted to require that there is at least one instance of w, at least one instance of x, at least one instance of y, and at least one instance of z.

Various “labels” may proceed nouns in this disclosure. Unless context provides otherwise, different labels used for a feature (e.g., “first circuit,” “second circuit,” “particular circuit,” “given circuit,” etc.) refer to different instances of the feature. The labels “first,” “second,” and “third” when applied to a particular feature do not imply any type of ordering (e.g., spatial, temporal, logical, etc.), unless stated otherwise.

Within this disclosure, different entities (which may variously be referred to as “units,” “circuits,” other components, etc.) may be described or claimed as “configured” to perform one or more tasks or operations. This formulation—“[entity] configured to [perform one or more tasks]”—is used herein to refer to structure (i.e., something physical). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function. This unprogrammed FPGA may be “configurable to” perform that function, however.

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for [performing a function]” construct.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

In this disclosure, various “modules” operable to perform designated functions are shown in the figures and described in detail (e.g., decision tree generation module 106, etc.). As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC. Accordingly, a module that is described as being “executable” to perform operations refers to a software module, while a module that is described as being “configured” to perform operations refers to a hardware module. A module that is described as “operable” to perform operations refers to a software module, a hardware module, or some combination thereof. Further, for any discussion herein that refers to a module that is “executable” to perform certain operations, it is to be understood that those operations may be implemented, in other embodiments, by a hardware module “configured” to perform the operations, and vice versa.

What is claimed is:

1. A method, comprising:
receiving, by a server system from a client device, a request to perform a particular operation via an application hosted by the server system, wherein the request specifies a first data value for a first parameter;
based on the first parameter specified in the request, dynamically reconstructing, by the server system, a first decision tree structure for an authorization policy used to determine whether to authorize the particular operation, wherein the first decision tree structure includes a first plurality of interconnected nodes organized in a first hierarchy having a plurality of levels, and wherein a highest level, of the plurality of levels, includes a first subset of nodes that correspond to the first parameter; and
determining, by the server system, whether to authorize the request to perform the particular operation using the first decision tree structure and retrieved user data.

2. The method of claim 1, further comprising:
based on the first decision tree structure, identifying, by the server system, a subset of paths through the first decision tree structure for which to retrieve the user data for the request.

3. The method of claim 2, wherein the identifying the subset of paths includes:
identifying a first node on the highest level in the first decision tree structure that corresponds to the first data value for the first parameter;
wherein the subset of paths through the first decision tree structure depend on the first node.

4. The method of claim 1, wherein the dynamically reconstructing the first decision tree structure includes:
in response to the request, retrieving a key-value representation of the authorization policy that specifies a plurality of conditions used to evaluate a given request to perform the particular operation, wherein the first parameter specified in the request corresponds to a first one of the plurality of conditions, and wherein the key-value representation includes, for the first condition, a first plurality of available values.

5. The method of claim 4, wherein the dynamically reconstructing the first decision tree structure further includes:
detecting that the first parameter is specified in the request;
selecting, from the key-value representation of the authorization policy, the first condition to correspond to the highest level of the first decision tree structure; and
creating the first subset of nodes, in the highest level of the first decision tree structure, based on the first plurality of available values for the first condition.

6. The method of claim 1, further comprising:
subsequent to the dynamically reconstructing the first decision tree structure, storing, by the server system, the first decision tree structure in a repository accessible to the server system;
receiving, by the server system, a second request to perform the particular operation, wherein the second request specifies a second data value for the first parameter;
in response to the second request, retrieving, by the server system, the first decision tree structure from the repository; and
determining, by the server system, whether to authorize the second request to perform the particular operation using the first decision tree structure.

7. The method of claim 6, further comprising:
receiving, by the server system, a third request to perform the particular operation, wherein the third request specifies a third data value for a second parameter;
dynamically reconstructing, by the server system, a second, different decision tree structure for the authorization policy, wherein a highest level of the second decision tree structure includes a second plurality of nodes corresponding to the second parameter;
based on the second decision tree structure, identifying, by the server system, a second subset of paths through the second decision tree structure for which to retrieve second user data; and
determining, by the server system, whether to authorize the third request using the second decision tree structure and the second user data.

8. The method of claim 7, further comprising:
storing, by the server system, the second decision tree structure in the repository;
monitoring, by the server system, usage of the first and second decision tree structures over a particular time period; and
determining, by the server system, whether to retain the first and second decision tree structures in the repository based on the usage.

9. The method of claim 1, further comprising:
reconstructing, by the server system, a third decision tree structure for the authorization policy, wherein a highest level of the third decision tree structure includes a third plurality of nodes corresponding to a third parameter;
subsequent to the reconstructing the third decision tree structure, receiving, by the server system, a fourth request to perform the particular operation;
based on the third decision tree structure, identifying, by the server system, a third subset of paths through the third decision tree structure for which to retrieve third user data; and
determining, by the server system, whether to authorize the fourth request using the third decision tree structure and the third user data.

10. The method of claim 1, further comprising:
receiving policy information indicative of the authorization policy, wherein the policy information specifies one or more policy rules associated with the particular operation; and
parsing the policy information to generate a key-value representation of the authorization policy, wherein the key-value representation specifies a plurality of conditions that are used to evaluate a given request to perform the particular operation.

11. A non-transitory, computer-readable medium having instructions stored thereon that are executable by a server system to perform operations comprising:
receiving, from a client device, a request to perform a particular operation via an application hosted by the server system, wherein the request specifies a first data value for a first parameter;
based on the first parameter specified in the request, dynamically reconstructing a first decision tree structure for an authorization policy used to determine whether to authorize the particular operation, wherein the first decision tree structure includes a first plurality of interconnected nodes organized in a first hierarchy having a plurality of levels, and wherein a highest level, of the plurality of levels, includes a first subset of nodes that correspond to the first parameter; and
determining whether to authorize the request to perform the particular operation using the first decision tree structure and retrieved user data.

12. The non-transitory, computer-readable medium of claim 11, wherein the dynamically reconstructing the first decision tree structure includes:
in response to the request, retrieving a key-value representation of the authorization policy that specifies a plurality of conditions used to evaluate a given request to perform the particular operation, wherein the first parameter specified in the request corresponds to a first one of the plurality of conditions, and wherein the key-value representation includes, for the first condition, a first plurality of available values.

13. The non-transitory, computer-readable medium of claim 12, wherein the dynamically reconstructing the first decision tree structure further includes:
detecting that the first parameter is specified in the request;
selecting, from the key-value representation of the authorization policy, the first condition to correspond to the highest level of the first decision tree structure; and
creating the first subset of nodes, in the highest level of the first decision tree structure, based on the first plurality of available values for the first condition.

14. The non-transitory, computer-readable medium of claim 11, wherein the operations further comprise:
based on the first decision tree structure, identifying a subset of paths through the first decision tree structure for which to retrieve the user data for the request, including by:
identifying a first node on the highest level in the first decision tree structure that corresponds to the first data value for the first parameter, wherein the subset of paths through the first decision tree structure depend on the first node.

15. The non-transitory, computer-readable medium of claim 11, wherein the operations further comprise:
receiving policy information indicative of the authorization policy, wherein the policy information specifies one or more policy rules associated with the particular operation; and
parsing the policy information to generate a key-value representation of the authorization policy, wherein the key-value representation specifies a plurality of conditions that are used to evaluate a given request to perform the particular operation.

16. A method, comprising:
receiving, by a server system from a client device, a request to perform a particular operation via an application hosted by the server system, wherein the request specifies a first data value for a first parameter;
accessing, by the server system, a repository that includes a plurality of decision tree structures corresponding to an authorization policy that is used to determine whether to authorize the particular operation;
based on the first parameter specified in the request, selecting, by the server system, a first one of the plurality of decision tree structures from the repository, wherein the first decision tree structure includes a first plurality of interconnected nodes organized in a first hierarchy having a plurality of levels, and wherein a highest level, of the plurality of levels, includes a first subset of nodes that correspond to the first parameter; and
determining, by the server system, whether to authorize the request to perform the particular operation using the first decision tree structure and retrieved user data.

17. The method of claim 16, further comprising:
based on the first decision tree structure, identifying, by the server system, a subset of paths through the first decision tree structure for which to retrieve the user data for the request, including by:
identifying a first node on the highest level in the first decision tree structure that corresponds to the first data value for the first parameter, wherein the subset of paths through the first decision tree structure depend on the first node.

18. The method of claim 16, further comprising:
receiving, by the server system, a second request to perform the particular operation, wherein the second request specifies a second data value for a second parameter;
based on the second parameter specified in the second request, selecting, by the server system, a second one of the plurality of decision tree structures from the repository, wherein the second decision tree structure includes a second plurality of interconnected nodes organized in a second hierarchy having a second plurality of levels, and wherein a highest level, of the second plurality of levels, includes a second subset of nodes that correspond to the second parameter; and
determining, by the server system, whether to authorize the second request to perform the particular operation using the second decision tree structure.

19. The method of claim 16, further comprising:
receiving, by the server system, a second request to perform the particular operation, wherein the second request specifies a second data value for a second parameter;
determining, by the server system, that the repository does not include, for the authorization policy, a second decision tree structure in which a highest level of the second decision tree structure corresponds to the second parameter;
dynamically reconstructing, by the server system, the second decision tree structure based on the second parameter specified in the second request; and
determining, by the server system, whether to authorize the second request to perform the particular operation using the second decision tree structure.

20. The method of claim 19, wherein the dynamically reconstructing the second decision tree structure includes:
retrieving a key-value representation of the authorization policy that specifies a plurality of conditions used to evaluate a given request to perform the particular operation, wherein the second parameter specified in the second request corresponds to a particular one of the plurality of conditions, and wherein the key-value representation includes, for the particular condition, a plurality of available values;
selecting, from the key-value representation of the authorization policy, the particular condition to correspond to the highest level of the second decision tree structure; and
creating a second subset of nodes, in the highest level of the second decision tree structure, based on the plurality of available values for the particular condition.
